(19) United States
(12) Patent Application Publication
(10) Pub. No.: US 2023/0376307 A1
(43) Pub. Date: Nov. 23, 2023

(54) STREAMING VIA HARDWARE ABSTRACTION LAYER

(71) Applicant: Google LLC, Mountain View, CA (US)

(72) Inventors: Carsten Isert, Munich (DE); Lenka Rímská, Munich (DE); Bernd Holzhey, Neubiberg (DE); Vlad Popa, München (DE); Tomasz Pawel Wasilczyk, Milpitas, CA (US); Enrico Granata, Los Altos, CA (US)

(21) Appl. No.: 18/042,614

(22) PCT Filed: Aug. 20, 2021
(86) PCT No.: PCT/US2021/046924

§ 371 Date: Feb. 23, 2023

Related U.S. Application Data
(60) Provisional application No. 63/071,537, filed on Aug. 28, 2020.

(51) Int. Cl. G06F 8/71; G06F 9/54

(52) U.S. Cl. CPC G06F 8/71; G06F 9/547

(57) ABSTRACT

In general, techniques are described by which to provide streaming via a hardware abstraction layer. A cartridge comprising a memory, and a processor may be configured to perform the techniques. The processor may execute a second version of an operating system, and receive a stream, via an interface and to a first version of the operating system executing on a processor of a head unit of a vehicle, information relating to an application executing in the application layer exposed by the first version of the operating system. The information relating to the application may include a first function call that conforms with the first version of the operating system, where the cartridge is communicatively coupled to the head unit. The interface may transform the first function call to a second function call that conforms with the second version of the operating system.

This application claims priority to U.S. Provisional Application No. 63/071,537, entitled “STREAMING VIA HARDWARE ABSTRACTION LAYER,” filed Aug. 28, 2020, the contents of which are hereby incorporated by reference as if set forth in their entirety herein.

### BACKGROUND

Reliability of vehicles is increasing to the point that the average life cycle of vehicles is at or nearing ten plus years of service. As vehicles age during the years of service, computing systems, including head units, electronic control units (ECUs), and the like, may increasingly become outdated, entering end of life in terms of technical support, maintenance (and other support), and support of new features. Moreover, head units and other computing systems are increasingly being seamlessly integrated into dashboards and other components of the vehicles such that replacement of the head units is becoming difficult due to unique form factors, inclusion of large and possibly expensive displays, etc.

Although upgrade of the head unit is possible, an upgrade to replace the head unit (and other computing systems) is often expensive, as the cost of replacing an entire head unit may require replacement of the screen and other (relatively) expensive components, which, while not necessary, is required (as the head unit often integrates the display and other expensive components into a single housing or replaceable unit) and difficult (as such head units are seamlessly integrated into each vehicle and specific to each make and model of the vehicle, potentially limiting availability of replacement head units and further possibly driving up the cost). As such, operators of vehicles may purchase an entirely new vehicle in an effort to gain access to newer technology, such as computing systems, including head units and other infotainment and other components, at considerable expense.

### SUMMARY

In general, various aspects of the techniques set forth in this disclosure are directed to streaming via an interface, such as a hardware abstraction layer (HAL) in a vehicle. Rather than replace the head unit or other computing systems of a vehicle, the techniques may enable a head unit or other computing system to interface with a supporting computing system that is communicatively coupled to the head unit. The supporting computing system may be a portable and relatively easily removable system that may execute a newer version of an operating system than the head unit and may provide a user of the vehicle with access to newer features supported by the newer version of the operating system being executed by the supporting computing system that may not be supported by the older version of the operating system being executed by the head unit. In this manner, a user of the vehicle may have access to newer features without replacing the entire head unit or the vehicle itself.

The head unit or other computing device may detect communicative coupling of the supporting device and, responsive to detecting the communicative coupling of the supporting computing device, begin streaming information relating to an application executing in an application layer (or in some examples, a framework layer) exposed by the first version of the operating system to a kernel layer exposed by the second version of the operating system. In addition to, or alternatively, the supporting computing device may begin streaming information relating to an application executing in an application layer (or in some examples, a framework layer) exposed by the second version of the operating system to a kernel layer exposed by the first version of the operating system. These streaming communications may be through an interface, such as a HAL, that may transform function calls such the function calls conform with the version of the operating system being executed on the receiving device and/or system. The supporting computing device may be replaceable or otherwise upgradeable to facilitate adaption of new features, support (in terms of, as an example, end of life services, such as technology support—including software patching and the like to address security and other concerns), and maintenance (in terms of, for example, hardware upgrades —such as processing capabilities, memory size, etc.).

Addition of the supporting computing device may allow for upgrades to the main computing unit (which is another way to refer to the “head unit” or other computing device) that is less expensive (as the supporting computing device is not seamlessly integrated into the vehicle, but only communicatively coupled to the head unit, thereby relieving expenses associated with the seamless integration, such as form factor, additional components—such as displays, global positioning systems (GPS), etc.). In addition, support of the addition of the supporting computing device may enable upgrades to the main computing device without having to separately replace the main computing device, thereby allowing for upgrade of the main computing device without having to replace the main computing device.

In this respect, various aspects of the techniques may provide an architecture which may ensure synchronization between the main computing device and the supporting computing device in such a manner to potentially provide a consistent user experience even though the main computing device and the supporting computing device may execute different versions of the operating system. As such, the techniques may improve operation of the main computing device itself (as facilitating an upgrade by way of the supporting computing device may extend the life of the head unit itself and reduce upgrade costs), while potentially maintaining a consistent user experience throughout upgrades to the supporting computing device.

In some examples, the main computing device and the supporting computing device may execute the same version of the operating system. In such examples, the supporting computing device may provide additional computing power and additional storage to the main computing device.

In one example, this disclosure describes a method comprising: executing, by one or more processors of a head unit of a vehicle, a first version of an operating system; executing, by one or more processors of a cartridge communicatively coupled to the head unit within the vehicle, a second version of the operating system; presenting an interface between an application layer exposed by the first version of the operating system and a kernel layer exposed by the second version of the operating system; streaming, via the interface and to the kernel layer exposed by the second version of the operating system, information relating to an application executing in the application layer exposed by the first version of the operating system, wherein the information relating to the application executing in the application layer exposed by the first version of the operating system comprises a first function call that conforms with the first version of the operating system; and transforming, by the interface, the first function call to a second function call that conforms with the second version of the operating system; and processing, by the second version of the operating system, the second function call.

In another example, this disclosure describes a method comprising: executing, by one or more processors of a head unit of a vehicle, a first version of an operating system; and streaming, via an interface and to a kernel layer exposed by a second version of the operating system executing on one or more processors of a cartridge information relating to an application executing in the application layer exposed by the first version of the operating system, wherein the information relating to the application executing in the application layer exposed by the first version of the operating system comprises a first function call that conforms with the first version of the operating system, the cartridge being communicatively coupled to the head unit, wherein the interface transforms a first function call that conforms with the first version of the operating system to a second function call that conforms with the second version of the operating system.

In another example, this disclosure describes a method comprising: executing, by one or more processors of a cartridge in a vehicle, a second version of an operating system; and receiving a stream, via an interface and to an application layer exposed by a first version of the operating system executing on one or more processors of a head unit of a vehicle information relating to an application executing in the application layer exposed by the first version of the operating system, wherein the information relating to the application executing in the application layer exposed by the first version of the operating system comprises a first function call that conforms with the first version of the operating system, the cartridge being communicatively coupled to the head unit, wherein the interface transforms a first function call to a second function call that conforms with the second version of the operating system.

In another example, this disclosure describes a system comprising: a head unit of a vehicle; an interface, the interface being communicatively coupled to the head unit and being between an application layer exposed by a first version of an operating system executing on one or more processors of the head unit and a kernel layer exposed by a second version of the operating system; and a cartridge, the cartridge being communicatively coupled to the interface and comprising one or more processors executing the second version of the operating system, wherein the first version of the operating system is configured to stream, via the interface and to the kernel layer exposed by the second version of the operating system, information relating to an application executing in the application layer exposed by the first version of the operating system, wherein the information relating to the application executing in the application layer exposed by the first version of the operating system comprises a first function call that conforms with the first version of the operating system, and wherein the interface is configured to transform the first function call to a second function call that conforms with the second version of the operating system, and wherein the second version of the operating system is configured to process the second function call.

In another example, this disclosure describes a head unit comprising: a memory and one or more processors implemented in circuitry and communicatively coupled to the memory, the one or more processors being configured to: execute a first version of an operating system; and stream, via an interface and to a kernel layer exposed by a second version of the operating system executing on one or more processors of a cartridge, information relating to an application executing in the application layer exposed by the first version of the operating system, wherein the information relating to the application executing in the application layer exposed by the first version of the operating system comprises a first function call that conforms with the first version of the operating system, the cartridge being communicatively coupled to the head unit, wherein the interface transforms a first function call that conforms with the first version of the operating system to a second function call that conforms with the second version of the operating system.

In another example, this disclosure describes a cartridge comprising: a memory and one or more processors implemented in circuitry and communicatively coupled to the memory, the one or more processors being configured to: execute a second version of an operating system; and receive a stream, via an interface and to an application layer exposed by a first version of the operating system executing on one or more processors of a head unit of a vehicle, information relating to an application executing in the application layer exposed by the first version of the operating system, wherein the information relating to the application executing in the application layer exposed by the first version of the operating system comprises a first function call that conforms with the first version of the operating system, the cartridge being communicatively coupled to the head unit, wherein the interface transforms the first function call to a second function call that conforms with the second version of the operating system.

In another example, this disclosure describes a computer-readable storage medium storing instructions, which, when executed cause one or more processors of a system in a vehicle to: execute a first version of an operating system; execute a second version of the operating system; present an interface between an application layer exposed by the first version of the operating system and a kernel layer exposed by the second version of the operating system; stream, via the interface and to the kernel layer exposed by the second version of the operating system, information relating to an application executing in the application layer exposed by the first version of the operating system, wherein the information relating to the application executing in the application layer exposed by the first version of the operating system comprises a first function call that conforms with the first version of the operating system; and transform the first function call to a second function call that conforms with the second version of the operating system; and process the second function call.

In another example, this disclosure describes a system comprising: means for executing, in a head unit of a vehicle, a first version of an operating system; means for executing, in a cartridge communicatively coupled to the head unit within the vehicle, a second version of the operating system; means for presenting an interface between an application layer exposed by the first version of the operating system and a kernel layer exposed by the second version of the operating system; means for streaming, via the interface and to the kernel layer exposed by the second version of the operating system, information relating to an application executing in the application layer exposed by the first version of the operating system, wherein the information relating to the application executing in the application layer exposed by the first version of the operating system comprises a first function call that conforms with the first version of the operating system; and means for transforming the first function call to a second function call that conforms with the second version of the operating system; and means for processing the second function call.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example computing system that is configured to provide a streaming interface between a main computing device and a supporting computing device for a vehicle in accordance with various aspects of the techniques described in this disclosure.

FIG. 2 is a block diagram illustrating an example system configured to provide a streaming interface between a head unit 302 and a cartridge according to the techniques of this disclosure.

FIG. 3 is a block diagram illustrating another example system configured to provide a streaming interface between a head unit and a cartridge according to the techniques of this disclosure.

FIG. 4 is a diagram illustrating an example of a vehicle that includes a computing system configured to operate in accordance with various aspects of the streaming interface techniques described in this disclosure.

FIG. 5 is a flowchart illustrating example operation of the computing system shown in FIG. 1 in performing various aspects of the streaming techniques described in this disclosure.

### DETAILED DESCRIPTION

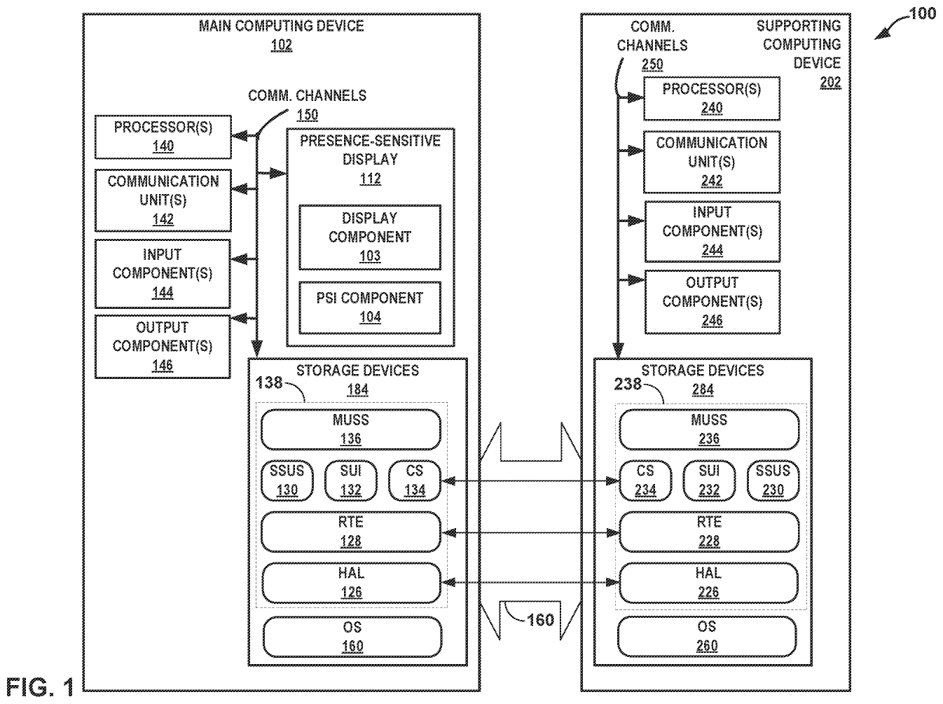

FIG. 1 is a block diagram illustrating an example computing system that is configured to provide a streaming interface between a main computing device and a supporting computing device for a vehicle in accordance with various aspects of the techniques described in this disclosure. As shown in the example of FIG. 1, a computing system 100 includes a main computing device 102 and a supporting computing device 202. Although described with respect to a vehicle, the computing system 100 may be utilized in different contexts, including standalone computing systems (including laptop computers, desktop computers, workstations and the like), gaming systems, cellular telephones (including so-called “smartphones”), media systems (including streaming media systems), audio/visual (A/V) receivers, televisions (including so-called “smart televisions”), smart speakers, smart watches, thermostats (including so-called “smart thermostats”), smart glasses, or any other computing system.

In any event, main computing device 102 is an example of vehicle computing device, such as head unit or other vehicular computing system (such as an electronic control unit —ECU). FIG. 1 illustrates only one particular example of main computing device 102, and many other examples of main computing device 102 may be used in other instances and may include a subset of the components included in example computing device 102 or may include additional components not shown in FIG. 1.

As shown in the example of FIG. 1, main computing device 102 includes presence-sensitive display 112, one or more processors 140, one or more communication units 142, one or more input components 144, one or more output components 146, and one or more storage devices 148. Storage devices 148 of main computing device 102 include a software hierarchy formed, in part, by a hardware abstraction layer 126 (“HAL 126”), an runtime environment 128 (“RTE 128”), a system and single user services (SSUS) module 130 (“SSUS 130”), a system user interface (SUS) module 132 (“SUS 132”), a car services (CS) module 134 (“CS 134”), and a multi-user service space (MUSS) module 136 (“MUSS 136”).

Communication channels 150 may interconnect each of the components 112, 140, 142, 146, and/or 148 for inter-component communications (physically, communicatively, and/or operatively) and thereby allow components 112, 140, 142, 146, and 148 to communicate with one another. In some examples, communication channels 150 may include a system bus, a network connection, one or more inter-process communication data structures, or any other components for communicating data (also referred to as information). Although shown as including components 112, 140, 142, 146, and 148, main computing device 102 may include other components or less components than those shown, where such components may be included in other control units such as a telematic control unit (TCU).

One or more communication units 142 of computing device 100 may communicate with external devices by transmitting and/or receiving data. For example, main computing device 102 may use one or more of communication units 142 to transmit and/or receive radio signals on a radio network such as a cellular radio network. In some examples, communication units 142 may transmit and/or receive satellite signals on a satellite network such as a Global Positioning System (GPS) network. Examples of communication units 142 include a network interface card (e.g. such as an Ethernet card), an optical transceiver, a radio frequency transceiver, a GPS receiver, or any other type of device that can send and/or receive information. Other examples of communication units 142 may include short wave radios (e.g., NFC. BLUETOOTH (including BLE)), GPS, 3G, 4G, 5G, and WIFI radios found in mobile devices as well as Universal Serial Bus (USB) controllers and the like.

One or more input components 144 of main computing device 102 may receive input. Examples of input are tactile, audio, kinetic, and optical input, to name only a few examples. Input components 144 of main computing device 102 include, in one example, a mouse, keyboard, touchpad, voice responsive system, video camera, buttons, scroll wheel, dial, control pad, microphone or any other type of device for detecting input from a human or machine. Input components 144 may include cameras. In some examples, input component 144 may be a presence-sensitive input component, which may include a presence-sensitive screen, touch-sensitive screen, etc. separate from presence-sensitive display 112.

One or more output components 146 of main computing device 102 may generate output. Examples of output are tactile, audio, and video output. Output components 146 of computing device 100, in some examples, include a presence-sensitive screen (possibly separate from presence-sensitive display 112), sound card, video graphics adapter card, speaker, cathode ray tube (CRT) monitor, liquid crystal display (LCD), organic light emitting diode (OLED), or any other type of device for generating tactile, audio and/or visual output to a human or machine.

In some examples, presence-sensitive display 112 of main computing device 102 may include functionality of input component 144 and/or output components 146. In the example of FIG. 1, presence-sensitive display 112 may include a presence-sensitive input (PSI) component 104 (“PSI component 104”), such as a presence-sensitive screen or touch-sensitive screen. In some examples, presence-sensitive input component 104 may detect an object at and/or near the presence-sensitive input component. As one example range, presence-sensitive input component 504 may detect an object, such as a finger or stylus that is within two inches or less of presence-sensitive input component 104. Presence-sensitive input component 104 may determine a location (e.g., an (x,y) coordinate) of the presence-sensitive input component at which the object was detected. In another example range, presence-sensitive input component 104 may detect an object two inches or less from presence-sensitive input component 104 and other ranges are also possible. Presence-sensitive input component 104 may determine the location of presence-sensitive input component 104 selected by a user's finger using capacitive, inductive, and/or optical recognition techniques.

In some examples, presence-sensitive display 112 may also provide output to a user using tactile, audio, or video stimuli as described with respect to output component 146. For instance, presence-sensitive display 112 may include display component 103 that displays a graphical user interface. Display component 103 may be any type of output component that provides visual output, such as described with respect to output components 146. While illustrated as an integrated component of main computing device 102, presence-sensitive display 112 may, in some examples, be an external component that shares a data or information path with other components of main computing device 102 for transmitting and/or receiving input and output. For instance, presence-sensitive display 512 may be a built-in component of main computing device 102 located within and physically connected to the external packaging of main computing device 102 (e.g., an in-vehicle screen mounted in a dashboard of a vehicle). In another example, presence-sensitive display 112 may be an external component of main computing device 102 located outside and physically separated from the packaging of main computing device 102 (e.g., a monitor, a projector, etc. that shares a wired and/or wireless data path with a electronic control unit of the vehicle). In some examples, presence-sensitive display 112, when located outside of and physically separated from the packaging of main computing device 102, may be implemented by two separate components: a presence-sensitive input component 104 for receiving input and a display component 103 for providing output.

One or more storage devices 184 within main computing device 102 may store information for processing during operation of main computing device 102 (e.g., computing device 102 may store data accessed by modules 126-136 during execution at main computing device 102). One or more storage devices 184 may store a first versions of an operating system 160 (OS 160). In some examples, storage component 184 is a temporary memory, meaning that a primary purpose of storage component 184 is not long-term storage. Storage devices 184 on main computing device 102 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage devices 184, in some examples, also include one or more computer-readable storage media. Storage devices 184 in some examples include one or more non-transitory computer-readable storage mediums. Storage devices 184 may be configured to store larger amounts of information than typically stored by volatile memory. Storage devices 184 may further be configured for long-term storage of information as non-volatile memory space and retain information after power on/off cycles. Examples of non-volatile memories include magnetic hard discs, optical discs, flash memories, or forms of electrically programmable memories (EPROM) or electrically erasable and programmable (EEPROM) memories. Storage devices 184 may store program instructions and/or information (e.g., data) associated with modules 126-136. Storage devices 184 may include a memory configured to store data or other information associated with modules 126-136.

One or more processors 140 may implement functionality and/or execute instructions associated with main computing device 102. Examples of processors 140 include application processors, display controllers, auxiliary processors, one or more sensor hubs, and any other hardware configure to function as a processor, a processing unit, or a processing device. Modules 126-136 may be operable (or, in other words, executed) by processors 140 to perform various actions, operations, or functions of main computing device 102. That is, modules 126-136 may form executable bytecode, which when executed, cause processors 140 to perform specific operations (and thereby causing main computing device 102 to become a specific-purpose computer by which to perform) in accordance with various aspects of the techniques described herein. For example, processors 140 of main computing device 102 may retrieve and execute instructions stored by storage devices 148 that cause processors 140 to perform the operations described herein that are attributed to modules 126-136. The instructions, when executed by processors 140, may cause main computing device 102 to store information within storage devices 148.

Supporting computing device 202 may include components similar to main computing device 102. As further shown in the example of FIG. 1, supporting computing device 202 may include one or more processors 240, one or more communication units 242, one or more input components 244, one or more output components 246, and one or more storage devices 284. Each of components 240-284 may be similar to, if not substantially similar to, respective components 140-184, as discuss in more detail above, except that supporting computing device 202 may not include a presence-sensitive display similar to presence-sensitive display 112 or any other visual, auditory, or other output device or interface.

Supporting computing device 202 also includes communication bus 250 interconnecting modules 240-284. Communication bus 250 may be similar to, if not substantially similar to, communication bus 150 discussed in more detail above.

Furthermore, storage devices 284 may store modules 226-236, which may be similar to, if not substantially similar to, respective modules 126-136. That is, storage devices 284 may store a HAL 226, OS 228, SSUS 230, SUI 232, CS 234, and MUSS 236. Storage devices 284 may also store a second version of an operating system 260 (OS 260). In some examples, second version of the operating system 260 is a different version of first version of the operating system 160. In other examples, second version of the operating system 260 is the same version of the operating system as first version of the operating system 160.

As described above, computing system 100 may be integrated or otherwise included within a vehicle. The vehicle may include one or more of a bicycle, a tricycle, a unicycle, a motorcycle, an automobile, farm equipment (such as a tractor, combine, etc.), construction equipment (a dump truck, crane, etc.), military vehicle or equipment (a tank, armament, etc.), a truck, a semi-tractor (or, in other words, a semi-trailer), aviation equipment (such as a plane), nautical equipment (such as a boat, carrier, submarine, etc.), or any other type of vehicle.

Reliability of vehicles is increasing to the point that the average life cycle of vehicles is at or nearing ten plus years of service. As vehicles age during the years of service, computing systems, such as computing system 100, including head units, electronic control units (ECUs), and the like, may increasingly become outdated, entering end of life in terms of technical support, maintenance (and other support), and support of new features. Moreover, head units and other computing systems, including main computing device 102, are increasingly being seamlessly integrated into dashboards and other components of the vehicles such that replacement of the head units (where main computing device 102 is one example) is becoming difficult due to unique form factors, inclusion of large and possibly expensive displays, etc.

Although upgrade of the head unit is possible, such an upgrade to replace the head unit (and other computing systems) is often expensive (as the cost of replacing an entire head unit may require replacement of the display and other (relatively) expensive components, which, while not necessary, is required (as the head unit often integrates the display and other expensive components into a single housing or replaceable unit) and difficult (as such head units are seamlessly integrated into each vehicle and specific to each make and model of the vehicle, potentially limiting availability of replacement head units and further possibly driving up the cost). As such, operators of vehicles may purchase an entirely new vehicle in an effort to gain access to newer technology, such as computing systems, including head units and other infotainment and other components, at considerable expense.

The migration path for acquiring updated computing systems may result in considerable expense (both in initial outlays of money to purchase a new or newer vehicle and in terms of upgrade costs for replacing head units) to operators that would like to access newer technology (e.g., a new head unit that offers extended functionality in terms of features provided by upgraded OS, applications, etc.). The expense of migration to newer technology may present a barrier to adoption of the newer technology, slowing uptake by operators of various features, that may include safety features, security features, data privacy features, and the like.

In accordance with various aspects of the techniques described in this disclosure, computing system 100 may implement a streaming interface between main computing device 102 and supporting communicating device 202. Rather than replace main computing device 102 (which may represent one example of a so-called “head unit” and as such be referred to as “head unit 102”) or other computing systems of a vehicle, the techniques may enable head unit 102 or other computing system to interface with supporting computing system 202 that is communicatively coupled to head unit 102, where information relating to an application executing in an application layer exposed by an operating system on one of the head unit 102 or supporting computing device 202 may be streamed to the other.

For example, one or more processors 140 of main computing device 102 may execute a first version of an operating system 160. One or more processors 240 of supporting computing device 202 may execute a second version of operating system 260. As main computing device 102 may be older than supporting device 202, the second version of operating 260 system may be different than the first version of operating system 160. For example, the second version of operating system 260 may include different APIs than the first version of operating system 160. In some examples, the second version of operating system 260 may implement function calls in a different manner than the first version of operating system 160. In some examples, second version of the operating system 260 may be a same version of the operating system as first version of the operating system 160.

System 100 may present an interface between an application layer (or in some examples, a framework layer) exposed by the first version of the operating system and a kernel layer exposed by the second version of the operating system 260. For example, HAL 126. HAL 226, or both HAL 126 and HAL 226 may be the interface. Head unit 102 may stream, via the interface and to the kernel layer exposed by the second version of the operating system 260, information relating to an application executing in the application layer exposed by the first version of the operating system. This information relating to the application executing in the application layer exposed by the first version of the operating system may include a first function call that conforms with the first version of the operating system. The interface, e.g., HAL 126, HAL 226, or both HAL 126 and HAL 226 may transform the first function call to a second function call that conforms with the second version of the operating system 260. Supporting computing device 202 may then process the second function call. Supporting computing device 202 may be replaceable or otherwise upgradeable to facilitate adaption of new features, support (in terms of, as an example, end of life services, such as technology support—including software patching and the like to address security and other concerns), and maintenance (in terms of, for example, hardware upgrades —such as processing capabilities, memory size, etc.).

Addition of supporting computing device 202 may allow for upgrades to main computing unit 102 (which is, again, another way to refer to the “head unit” or other computing device) that are less expensive (as supporting computing device 202 is not seamlessly integrated into the vehicle, but only communicatively coupled to head unit 102, thereby relieving expenses associated with the seamless integration, such as form factor, additional components—such as displays, global positioning systems (GPS), etc.). In addition, support of the addition of supporting computing device 202 may enable upgrades to main computing device 102 without having to separately replace main computing device 102, thereby allowing for upgrade of main computing device 102 without having to replace main computing device 102.

In this respect, various aspects of the techniques may provide a streaming interface to ensure synchronization between main computing device 102 and supporting computing device 202 in such a manner to potentially provide a consistent user experience even though main computing device 102 and the supporting computing device 202 may execute different versions of the runtime environment. As such, the techniques may improve operation of main computing device 102 itself (as facilitating upgrade by way of supporting computing device 202 may extend the life of head unit 102 itself, reducing upgrade costs and promoting improved functionality as offloading processing to supporting computing device 202 may result in improved processing, storage, and/bandwidth), while potentially maintaining a consistent user experience throughout upgrades to supporting computing device 202.

In operation, main computing device 102 may initially execute a first container 138 that enables execution of a first instance of an runtime environment (e.g., RTE 128). As described above, main computing device 102 may include the above noted software hierarchy. As such, HAL 126 may execute as a kernel software shim between a kernel of RTE 128 to provide seamless interaction between RTE 128 and underlying hardware of the vehicle (which is not shown for ease of illustration). Hardware components of the vehicle may include a GPS system, an automation system (such as self-driving systems and/or dynamic cruise control systems), heating, ventilation, and air condition (HVAC) systems, window systems (for controlling operation of the windows), interior lighting systems (for controlling operation of various interior lights), exterior lighting systems (for controlling operation of various exterior lights), safety systems (including, for example, automatic breaking systems—ABS, lane assist systems, attention-based safety systems, etc.), heated seating systems, cooled seating systems, or any other system present in vehicles.

As such, RTE 128 may execute within HAL 126, where HAL 128 may intercept commands or other output signals issued by RTE 128 and translate or transform the RTE-specific commands to vehicle-specific commands supported by the underlying vehicle hardware while also translating vehicle-specific data into RTE-specific data supported by RTE 128. Translation of the OS-specific commands and the vehicle-specific data may occur transparently to RTE 128, allowing separate development of HAL 126 from RTE 128 and thereby facilitate adoption of a general RTE 128 with a shim (e.g., HAL 126) tailored for individual vehicles (which may vary across make and model in terms of original equipment manufacturer—OEM—hardware and/or components).

RTE 128 may execute in the above-mentioned kernel space to provide an execution environment for system level applications and user applications. In the example of FIG. 1, SSUS 130, SUI 132, and CS 134 may each represent system level applications that execute within the execution environment provided by RTE 128. RTE 128 may grant each of SSUS 130, SUI 132, and CS 134 system level privileges that permit increased access to the underlying vehicle hardware, while RTE 128 grants user-specific privileges to applications executing within MUSS 136 that are more restrictive than the system level privileges granted to each of SSUS 130, SUI 132, and CS 134. The system level privileges may allow increased access (in terms of permissions to access or priority) to the vehicle hardware components compared to the user-specific privileges. As an example, SSUS 130, SUI 132, and CS 134 may access one or more of the hardware systems or components of the vehicle to control operation of the hardware systems or components while MUSS 136 may only access data provided by the hardware systems or components of the vehicle (such as GPS coordinates output by the GPS system, ambient temperature output by the HVAC system, etc.).

SSUS 130 may represent a module configured to execute single-user services (e.g., services that are common across all users, and as such may also be referred to as “common services”) and system services (e.g., first party applications that are installed across all users and present one or more system services for use by all users of main computing device 102). SUI 132 may represent a module configured to present a system-level user interface with which the operator of the vehicle may interact to control various operations of the vehicle as well as launch or otherwise initiate execution of applications (as represented by MUSS 136). CS 134 may represent a module configured to interface (e.g., an API) with various car services, including GPS systems, HVAC systems, seating systems, window systems, or any other the other systems listed more exhaustively elsewhere herein.

MUSS 136 may represent one or more modules that provide individual user profiles that include specific third party applications, user-specific automotive services (associated with an individual user), and other user-specific data or information. MUSS 136 may execute in the application space maintained by the underlying RTE 128. MUSS 136 may, in this respect, represent a module executing in application space to provide extended software capabilities by way of applications that can be downloaded and/or installed to extend the capabilities of main computing device 102.

Main computing device 102 may also initially execute (although not shown in FIG. 1 for ease of illustration) a second container 238 that enables execution of a second instance of runtime environment (e.g., RTE 228), where RTE 128 and RTE 228 may be configured to jointly present a user interface (e.g., as provided by SUI 132 and 232) by which an operator of the vehicle controls functionality of the vehicle. Main computing device 102 may execute container 138 as a primary or host container 138 and the container 238 as a secondary of client container 238, where client container 238 operates to support execution of host container 138. As such, client container 238 may operate on behalf of host container 138 and may not execute independent of host container 138. Although described as operating on behalf of host container 138, client container 238 may execute independent of host container 138, where host container 138 may, in this example, represent a shim for passing data to client container 238.

Main computing device 102 may execute (via, as noted above, processors 140) container 138, which may invoke execution of RTE 128 (and underlying HAL 126). RTE 128 may, via interactions with input components 144 and/or communication units 142, detect supporting computing device 202 in communication with main computing device 102. That is, supporting computing device 202, upon being connected to main computing device 102, may power on (when powered via the communication interface) and execute a second version of an operating system 260 that is different than the first version of the operating system 160 being executed on main computing device 102 or a lightweight operating system or other low-level software (such as firmware, etc.) by which to interface, via output components 248 and/or communication units 242, with main computing device 102. In some examples, the second version of the operating system 260 may be a same version of the operating system as first version of the operating system 160. RTE 128 may then detect communicative coupling with supporting computing device 202, which may involve a protocol or other application programmer interface (API) call to establish communication between main computing device 102 and supporting computing device 202.

The connection between main computing device 102 and supporting computing device 202 is shown as connection 160 in the example of FIG. 1. Connection 160 may include a wireless connection, a wired connection (where connection is established via physical wire, such as a USB connection of any version—1.0, 2.0, 3.0, etc.), or a combination of wired (e.g., for power) and wireless connection. Connection 160 may include a universal automotive link or a remote procedure call.

Responsive to detecting supporting computing device 202, RTE 128 may transfer container 238 to supporting computing device 202. RTE 128 may transfer container 238 via output components 146 and/or communication units 142 to supporting computing device 202. Supporting computing device 202 may receive container 238, and execute the container 238 to establish a software hierarchy similar to that described above with respect to main computing device 102, thereby facilitating execution of HAL 226, RTE 228, SSUS 230, SUI 232, CS 234, and MUSS 236.

In effect, main computing device 102 may execute an overall RTE in segments or partitions, in which a first partition of the RTE (e.g., RTE 128) may execute in conjunction with a second partition of the RTE (e.g., RTE 228) to support the system and application space in which SSUS 130, 132, SUI 132, 232, CS 134, 234, and MUSS 136 and 236 execute. Main computing system 102 may execute containers 138 and 238 until detecting that supporting computing device 202 is communicatively coupled to main computing device 102.

Main computing device 102 may, prior to detecting communicative coupling with supporting computing device 202, execute both partitions (e.g., containers 138 and 238) of the overall RTE in a manner similar to, if not substantially similar to, that described below with respect to execution of a single container (e.g., container 138). In other words, when executing both of containers 138 and 238, main computing device 102 may continue to relay and synchronize data between containers 138 and 236, executing container 238 to support the application space in which MUSS 136 and 236 executes.

Transferring of container 238 to supporting computing device 202 may, in this way, offload execution of the container 238 to supporting computing device 202, which may allow main computing device 102 to reduce processing cycle, memory, and/or bandwidth consumption. As such, RTE 128 may operate as the host RTE relative to RTE 228, which operates as a client RTE. RTE 128 may redirect user input and other data to RTE 228, which may process the user input or other data and coordinate with RTE 128 to present any resulting outputs (e.g., via presence-sensitive display 112).

For example, HAL 226 may interface with HAL 126 to relay commands or other data from RTE 228, SSUS 230, and MUSS 236 that may control or otherwise update various settings associated with vehicle hardware components. Likewise, HAL 126 may relay command or other data from the vehicle hardware components to RTE 228, SSUS 230, and MUSS 236. In addition, RTE 128 and RTE 228 may exchange system settings, user settings, and other data or information to synchronize the various types of data in order to jointly execute a single instance of the RTE. In some examples, RTE 128 may have a particular version that is different than a version of the RTE 228, where RTE 128 may present a common API with which to interface with the RTE 228 that is the same or backwards compatible with the API used by RTE 228 to interface with the RTE 128 (despite having different executable code that is upgraded or more processor, memory, and/or bandwidth intensive than the executable code of the RTE 128). Furthermore, CS 234 and CS 134 may relay commands or other data between each other to synchronize support of car services between main computing device 102 and supporting computing device 202.

RTE 128 may, in this respect, interface with RTE 228 executed by supporting computing device 202 to jointly present the user interface by which the operator of the vehicle controls the functionality of the vehicle. RTE 128 may synchronize or otherwise maintain data structures that enable RTE 228 to obtain consistent state and other informational data with that maintained by RTE 128, both regarding the current operator (or, in other words, user of computing system 100) and the vehicle in which computing system 100 is integrated. As such, RTEs 128 and 228 may represent an instance of a distributed runtime environment capable of or otherwise configured to execute across one or more devices (e.g., main computing device 102 and/or supporting computing device 202) in order to jointly present the user interface by which to interact with the operator of the vehicle and the vehicle itself.

In order to facilitate the execution of applications on either main computing device 102 or supporting computing device 202, an interface may be provided to share hardware interfaces between main computing device 104 and supporting computing device 202. In some examples, this interface may provide access by an application executed on one device to a kernal on the other device. Due to the fact that the first version of the operating system 160 on main computing device 102 may be different than the second version of the operating system 260 on supporting computing device 202, all relevant interfaces of main computing device 102 and supporting computing device 202 may communicate through an interface that manages versions and provides serialization. In some examples, this interface is may be a HAL or portion of a HAL, such as HAL 126, HAL 226, or both HAL 126 and HAL 226.

In some examples, the first version of the operating system 160 and the second version of the operating system 260 may be the same version of the operating system. In these cases, supporting computing device 202 may provide additional processing power and storage to main computing device 102 through the interface.

In some examples, main computing device 102 may stream all of the signals of interest to the cartridge. For example, main computing device 102 may stream microphone data, Bluetooth data, vehicle properties (e.g., HVAC properties, odometry, etc.), control information (e.g., rotary control information, etc.) vehicle camera data, or other signals of interest based on which use case is being implemented. Main computing device 102 may transmit these signals to the second version of the operating system 260 on the supporting computing device 202 using a HAL such that the signals look like they are coming directly from the hardware. In some examples, supporting computing device 202 may stream signals through the interface to main computing device 102. In this manner, supporting computing device 202 may provide features to an operator of the vehicle that may not be compatible with the version of the operating system being executed on main computing device 102. For example, a next generation assistant may be executed offline on supporting computing device 202 where main computing device 102 may not be configured to support the offline execution of the next generation assistant. In another example, supporting computing device 202 may execute a video analysis or video processing application that main computing device 102 may be unable to execute due to main computing device 102 not having enough processing power.

In this way, various aspects of the techniques may provide a streaming interface between main computing device 102 and supporting computing device 202 in such a manner to potentially provide a consistent user experience even though main computing device 102 and the supporting computing device 202 may execute different versions of the runtime environment (as described in more detail below). As such, the techniques may improve operation of main computing device 102 itself (as facilitating upgrade by way of supporting computing device 202 may extend the life of head unit 102 itself, reducing upgrade costs and promoting improved functionality as offloading processing to supporting computing device 202 may result in improved processing, storage, and/bandwidth), while potentially maintaining a consistent user experience throughout upgrades to supporting computing device 202.

A HAL, such as HAL 126, may provide an interface based on operations with car properties. Such operations may include listing available properties, reading property values, writing property values, subscribing to property updates, or unsubscribing to property updates, for example. In some examples, the property identifications may include some additional information, such as which area of the vehicle to which the property relates (e.g., global, driver's seat, etc.). In some examples, HAL 126 is not accessible by ordinary applications, but may be accessible through a car services application. In some examples, HAL 126 runs in a separate process (for example, a HAL service daemon). In some examples, HAL 126 maintains an extent of compatibility of higher layers of different versions of the operating system.

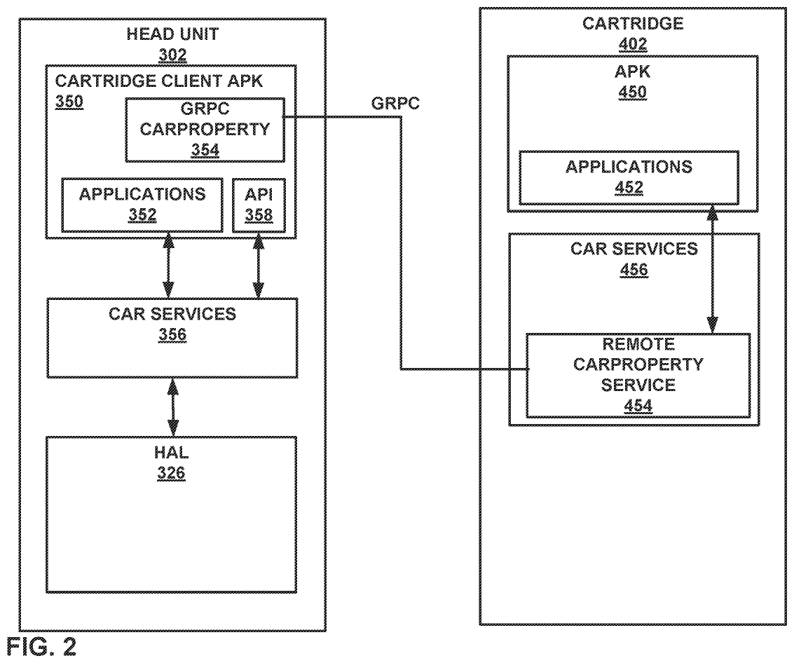

FIG. 2 is a block diagram illustrating an example system configured to provide a streaming interface between a head unit and a cartridge according to the techniques of this disclosure. Head unit 302, which may be an example of main computing device 102, is depicted along with cartridge 402, which may be an example of supporting computing device 202. Head unit 302 includes cartridge client APK 350 which may be an application space for executing applications 352. Cartridge client APK 350 may include GRPC CarProperty 354 which may present an interface for communicating with cartridge 402. GRPC CarProperty 354 may communicate with RemoteCarPropertyService 454 in cartridge 402 using a remote procedure call, such as a GRPC call.

Cartridge 402 may include APK 450, which may be an application space for applications 452 executed on cartridge 402. Applications 452 may interact with head unit 302 through car services 456 and through RemoteCarPropertyService 454. Car services 456 may be positioned between a kernel layer and an application layer and contain privileges enabling car services 456 to access the kernel space. In some examples, car services 456 may be an example of a kernel space. In any event, car services 456 may provide access to a kernel space, for example to applications 452 and to GRPC CarProprty 354.

In the example of FIG. 2, function calls to may be placed between GRPC CarProperty 354 and RemoteCarPropertyService 454. API 358 may provide by the framework to process these function calls and retrieve the required data.

In the example of FIG. 2, GRPC CarProperty 354 interacts with RemoteCarPropertyService on the cartridge 402, but no HAL is used on cartridge 402 for interacting with head unit 302. While applications 352 may processes operations with vehicle properties (e.g., reading, writing, etc.) by calling to HAL 326. In some examples, applications 352 interact with HAL 326 through car services 356. In some examples, car services 356 may be positioned between a kernel layer and an application layer and contain privileges enabling car services 356 to access the kernel space. In some examples, car services 356 may be an example of a kernel space. In any event, car services 356 may provide access to a kernel space, for example to applications 356 and to RemoteCarPropertyService 454. In this manner, cartridge 402 may gain access to the vehicle properties.

The example of FIG. 2 may have some limitations. Access to car properties may be protected by various permissions which may be on per property basis. Many of these properties may be protected by system/signature permissions. In this example, cartridge client APK 350 may need to be signed with the system key to gain access to the vehicle properties.

Mapping between a car property and the required permission may be performed by an application in applications 352. However, the technique for retrieving the required permission for a given car property may be hidden from cartridge client APK 350. Therefore, the required permissions may be unavailable to RemoteCarPropertyService 454. So, in the example of FIG. 2, it may be necessary to disable permission checks in order to provide access to the vehicle properties to RemoteCarPropertyService 454.

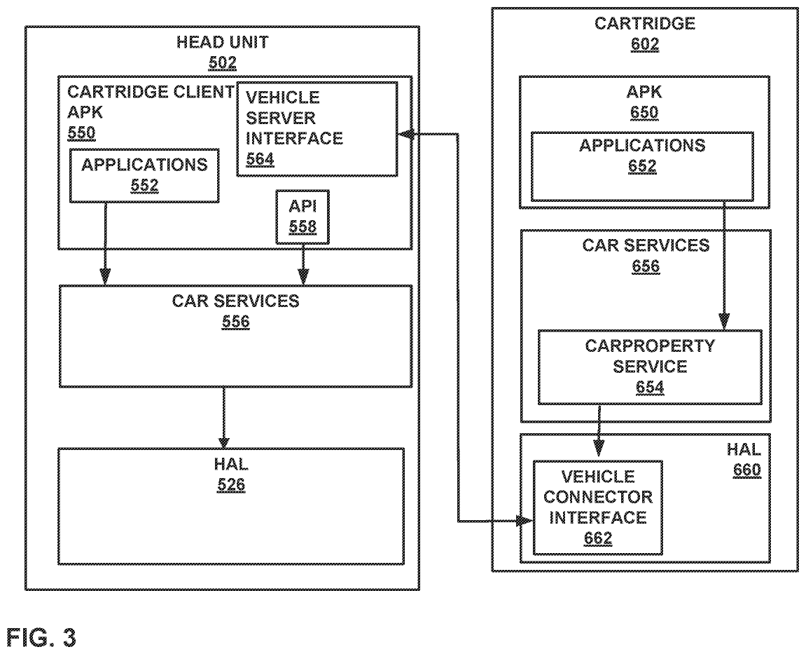

FIG. 3 is a block diagram illustrating another example system configured to provide a streaming interface between a head unit and a cartridge according to the techniques of this disclosure. Head unit 502, which may be an example of main computing device 102, is depicted along with cartridge 602, which may be an example of supporting computing device 202. Head unit 502 includes cartridge client APK 550 which may be an application space for executing applications 552. Cartridge client APK 550 may include vehicle server interface 564, which may present an interface for communicating with cartridge 602. Vehicle server interface 564 may communicate with vehicle connector interface 662 in HAL 660 of cartridge 602. Cartridge client APK 550 may also include API 558 to facilitate communications with car services 556 and HAL 526, similar to API 538 of FIG. 2. In some examples, rather than be located in cartridge client APK 550, vehicle server interface 564 may be located in car services 556. In some examples, car services 556 may be positioned between a kernel layer and an application layer and contain privileges enabling car services 556 to access the kernel space. In some examples, car services 556 may be an example of a kernel space. In any event, car services 356 may provide access to a kernel space, for example to applications 556 and to vehicle connector interface 662.

Cartridge 602 may include APK 650, which may be an application space for applications 652 executed on cartridge 602. Applications 652 may interact with head unit 502 through CarPropertyService 654 and vehicle connector interface 662. In some examples, applications 652 may interact with head unit 502 directly through vehicle connector interface 662 rather than through both CarPropertyService 654 and vehicle connector interface 662.

In some examples, a HAL may be implemented in two logical parts: 1) a part that maintains the local state of vehicle properties (caching of the vehicle property values, managing of subscriptions, batch notifications, etc.) and 2) a part that communicates with the vehicle. In some examples, a HAL may be virtualized and/or these two components may be separately implemented. In some examples, a HAL may include a vehicle connector interface, such as vehicle connector interface 662, for communicating with the vehicle (across the VM boundary in the virtualization case) and a vehicle server interface, such as vehicle server interface 564, for processing requests from the vehicle connector interface.

Vehicle connector interface 662 and vehicle server interface 564 may be relatively small and stable abstraction of the communication portions of a HAL, such as HAL 126. In some examples, vehicle connector interface 662 may be implemented on cartridge 602 and vehicle server interface 564 may be implemented on head unit 502 as shown in the example of FIG. 3.

Cartridge 602 may use UAL over USB to communicate with head unit 502. UAL may provide a bidirectional stream for exchanging messages between the two devices. In some examples, UAL may support different protocol domains, each consisting of one or more protocol modules, which in turn may provide different services. One of the protocol domains may be a cartridge protocol domain. One of the cartridge protocol modules may be dedicated to HAL streaming, providing services for exchanging data corresponding to an IVehicleServer interface.

The IVehcieServer interface looks like this:

```
// Vehicle side server
class IVehicleServer {
public:
  // receive the get property config request from HAL
  // return a list of all property config
  virtual std::vector<VehiclePropConfig> onGetAllPropertyConfigRequest( ) = 0;
  // receive the set property request from HAL
  // process the setting and send the status code back, also return the status code
  virtual StatusCode onSetProperty(const VehiclePropValue &value) = 0;
  // receive a new property value from car (via direct connection to the car,
  // e.g., CAN bus); forward the value to HAL
  virtual void onPropertyValueFromCar(const VehiclePropValue &value) = 0;
};
```

So, the streaming interface may be implemented using two UAL services —VhalSource for the head unit and VhalSink for the cartridge. UAL protocol messages exchanged between these two services may look like this:

```
// Sent from Cartridge to the VhalSource service on the headunit to request metadata
// describing all the available VHAL properties
message GetAllPropertyConfigRequest {
}
// Response from the VhalSource service with description of all the supported
// vehicle properties
message GetAllPropertyConfigResponse {
repeated VehiclePropertyConfig vehicle_property_config = 1;
}
// Sent from Cartridge to the VhalSource service in order to modify a vehicle
// property's value
message SetPropertyValueRequest {
  optional VehiclePropertyValue property_value = 1;
}
// Sent back from headunit to indicate if the property's value was successfully modified
message SetPropertyValueResponse {
  optional StatusCode status_code = 1;
}
// Sent from the headunit to the VhalSink service on Cartridge whenever VHAL property
// values change
message PropertyValueUpdate {
  repeated VehiclePropertyValue property_value = 1;
}
```

In some examples, vehicle connector interface 662 may reside inside HAL 660 on cartridge 602. In some examples, vehicle server interface 564 may reside in an application space, such as cartridge client APK 550 and may use API 358 and car services 356 for accessing car properties. In other examples, vehicle server interface 564 may reside in car services 556. In yet another example, the vehicle server interface may reside in HAL 326.

In some examples, one or more processors of head unit 502 of a vehicle may execute a first version of an operating system 160 (FIG. 1). One or more processors of cartridge 602 may execute a second version of the operating system 260 (FIG. 1). Cartridge 602 may be communicatively coupled to head unit 502 within the vehicle. In some examples, the second version of the operating system 260 may be different than the first version of the operating system 160. In some examples, the second version of the operating system 260 may be the same as the first version of the operating system 160. Head unit 502 and cartridge 602 may present an interface, e.g., vehicle connector interface 662 and vehicle server interface 564, between an application layer (e.g., cartridge client APK 550) exposed by the first version of the operating system 160 and a kernel layer (e.g., car services 656) exposed by the second version of the operating system 260. Head unit 502 may stream, via the interface (e.g., vehicle connector interface 662 and vehicle server interface 564) and to the kernel layer (e.g., car services 656) exposed by the second version of the operating system 260, information relating to an application (e.g., of applications 552) executing in the application layer (e.g., cartridge client APK 550) exposed by the first version of the operating system 160. The information relating to the application (e.g., one of applications 552) executing in the application layer (e.g., cartridge client APK 550) exposed by the first version of the operating system 160 may include a first function call that conforms with the first version of the operating system 160. The interface (e.g., vehicle connector interface 662 and vehicle server interface 564) may transform the first function call to a second function call that conforms with the second version of the operating system 260. Cartridge 602 may process the second function call.

In some examples, head unit 502 streams the information relating to the application (e.g. one of applications 552) executing in the application layer (e.g., cartridge client APK 550) exposed by the first version of the operating system 160 by generating a plurality of packages, the plurality of packages containing the information relating to the application (e.g. one of applications 552) executing in the application layer (e.g., cartridge client APK 550) exposed by the first version of the operating system 160. Head unit 502 may serialize the plurality of packages. Head unit 502 may provide the serialized plurality of packages to cartridge 602 via the interface (e.g., vehicle connector interface 662 and vehicle server interface 564).

In some examples, cartridge 602 processes the second function call by processing, by an application (e.g., one of applications 652) executing in an application layer (e.g., APK 650) exposed by the second version of the operating system 260, the information relating to the application (e.g., one of applications 552) executing within the application layer (e.g., cartridge client APK 550) exposed by the first version of the operating system 160.

In some examples, the application (e.g., one of applications 652) executing in the application layer (e.g., APK 650) exposed by the second version of the operating system 260 generates a third function call that conforms with the second version of the operating system 260 in response to the second function call. Cartridge 602 may provide, to the interface (e.g., vehicle connector interface 662 and vehicle server interface 564), the third function call. The interface (e.g., vehicle connector interface 662 and vehicle server interface 564) may transform the third function call to a fourth function call that conforms with the first version of the operating system 160. Head unit 502 may process the fourth function call.

In some examples, the interface (e.g., vehicle connector interface 662 and vehicle server interface 564) is a first interface and one or more processors of head unit 502 and/or one or more processors of cartridge 602 may present a second interface (e.g., vehicle connector interface 662 and vehicle server interface 564) between an application layer (e.g., APK 650) exposed by the second version of the operating system 260 and a kernel layer (e.g., via car services 556) exposed by the first version of the operating system 160. In some examples, the first interface (e.g., vehicle connector interface 662 and vehicle server interface 564) is the same as the second interface (e.g., vehicle connector interface 662 and vehicle server interface 564). In other examples, the first interface (e.g., vehicle connector interface 662 and vehicle server interface 564) is different than the second interface (not shown for simplicity purposes). Cartridge 602 may stream, via the second interface (e.g., vehicle connector interface 662 and vehicle server interface 564) and to the kernel layer exposed by the first version of the operating system 160, information relating to an application (e.g., one of applications 652) executing in the application layer (APK 650) exposed by the second version of the operating system 260. The information relating to the application (e.g., one of applications 652) executing in the application layer (e.g. APK 650) exposed by the second version of the operating system 260 may include a fifth function call that conforms with the second version of the operating system 260. The interface (e.g., vehicle connector interface 662 and vehicle server interface 564) may transform the fifth function call to a sixth function call that conforms with the first version of the operating system 160. Head unit 502 may process the sixth function call.

In some examples, the plurality of packages is a first plurality of packages and the serialized plurality of packages is a first serialized plurality of packages. In some examples, cartridge 602 streams the information relating to the application executing in the application layer (or in some examples, a framework layer) exposed by the second version of the operating system 260 by generating a second plurality of packages. The second plurality of packages may contain information relating to the application (e.g., one of applications 652) executing in the application layer (e.g., APK 650) exposed by the second version of the operating system 260. Cartridge 602 may serialize the second plurality of packages. Cartridge 602 may provide to head unit 502 via the second interface (e.g., vehicle connector interface 662 and vehicle server interface 564), the second serialized plurality of packages.

In some examples, head unit 502 processes the sixth function call by processing, by an application (e.g., one of applications 552) executing in an application space (e.g., cartridge client APK 550) of the first version of the operating system 160, the information relating to the application (e.g., one of applications 652) executing in the application layer (e.g., APK 650) exposed by the second version of the operating system 260.

In some examples, an application (e.g., one of applications 552) executing in the application layer (e.g., cartridge client APK 550) exposed by the first version of the operating system 160, may generate a seventh function call that conforms with the first version of the operating system 160 in response to the sixth function call. Head unit 502 may provide to the second interface (e.g., vehicle connector interface 662 and vehicle server interface 564) the seventh function call. The second interface (e.g., vehicle connector interface 662 and vehicle server interface 564) may transform the seventh function call to an eighth function call that conforms with the second version of the operating system 260. Cartridge 602 may process the eighth function call.

In some examples, the first interface (e.g., vehicle server interface 564) is presented by the one or more processors of head unit 502. In some examples, the first interface (e.g., vehicle connector interface 662) is presented by the one or more processors of cartridge 602. In some examples, the first interface (e.g., vehicle connector interface 662 and vehicle server interface 564) is presented by the one or more processors of head unit 502 and the one or more processors of cartridge 602.

In some examples, the second interface (e.g., vehicle server interface 564) is presented by the one or more processors of head unit 502. In some examples, the second interface (e.g., vehicle connector interface 662) is presented by the one or more processors of cartridge 602. In some examples, the second interface (e.g., vehicle connector interface 662 and vehicle server interface 564) is presented by the one or more processors of head unit 502 and the one or more processors of cartridge 602.

In some examples, the first interface (e.g., vehicle connector interface 662 and vehicle server interface 564) comprises a hardware abstraction layer. In some examples, the first version of the operating system 160 and the second version of the operating system 260 communicate via UAL. In some examples, the first version of the operating system 160 and the second version of the operating system 260 communicate via a USB connection. In some examples, the first version of the operating system 160 and the second version of the operating system 260 communicate via a remote procedure call. In some examples, cartridge 602 is a removable device. In some examples, the first interface provides a bidirectional stream for exchanging function calls between the first version of the operating system 160 and the second version of the operating system 260.

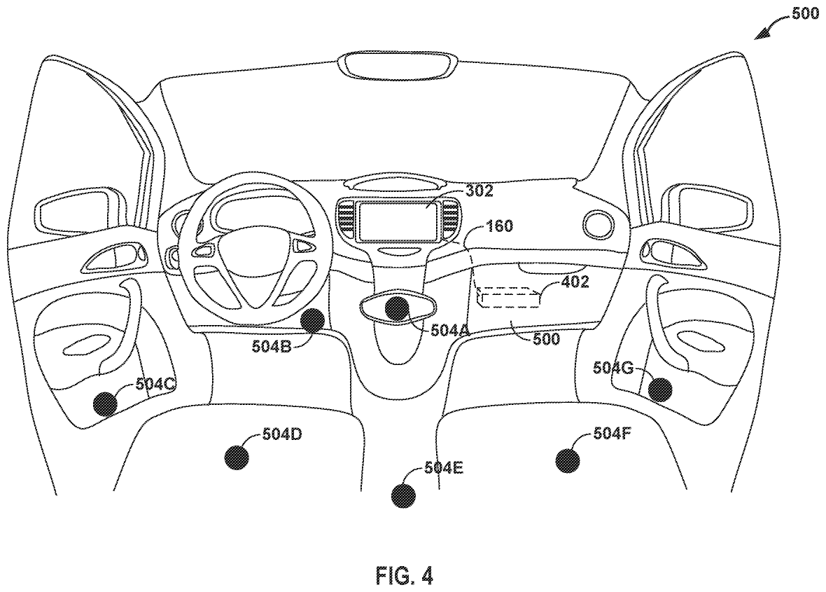

FIG. 4 is a diagram illustrating an example of a vehicle that includes a computing system configured to operate in accordance with various aspects of the streaming interface techniques described in this disclosure. As shown in the example of FIG. 4, an interior of vehicle 500 may include a computing system in which head unit 302 is communicatively coupled (e.g., via connection 160) to cartridge 402, which may reside in a glovebox 500 of vehicle 500. Cartridge 402 and connection 160 is shown in dashed lines to indicate that cartridge 402 and USB connection 160 are installed behind the dashboard (for connection 160) and glovebox cover (for cartridge 402) and therefore not visible when viewed by an operator of vehicle 500. Although not shown, cartridge 402 may include another USB port (or other interface port) by which to interface with yet another computing device, such as a smartphone, laptop computer, desktop computer, workstation, gaming system, etc.

Although shown as being installed in glovebox 500, cartridge 402 may be installed anywhere in vehicle 500 where power is available to be provided to cartridge 402. As such, cartridge 402 may be installed in a center dash console location 504A, mounted below driver dash location 504B, a driver door location 504C, an under driver seat location 504D, a center arm rest console location 504E, an under passenger seat location 504F, and/or a passenger door location 504G, as well as any other location at which power is available (but not shown in the example of FIG. 4) such as a rear trunk, a forward trunk, under a rear passenger seat, a rear passenger door, etc.

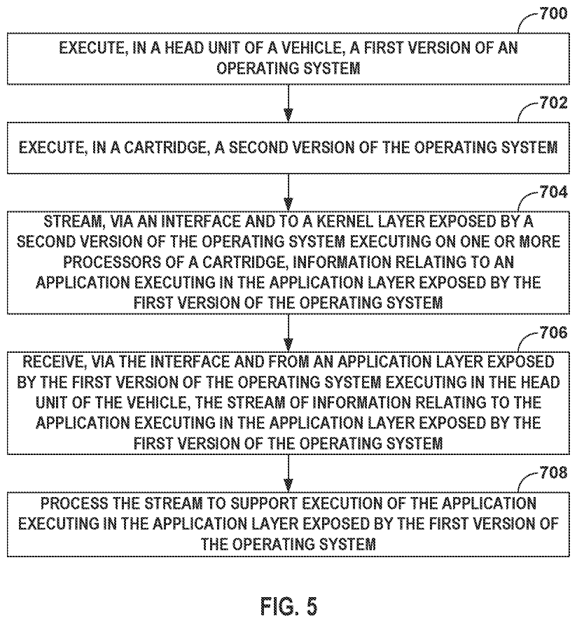

FIG. 5 is a flowchart illustrating example operation of the computing system shown in FIG. 1 in performing various aspects of the streaming techniques described in this disclosure. As described above, one or more processors 140 of main computing device 102 may execute a first version of an operating system 160 (700). One or more processors 240 of supporting computing device 202 (which may also be referred to as a cartridge 202) may execute a second version of operating system 260 (702). As main computing device 102 may be older than supporting device 202, the second version of operating 260 system may be different than the first version of operating system 160. For example, the second version of operating system 260 may include different APIs than the first version of operating system 160. In some examples, the second version of operating system 260 may implement function calls in a different manner than the first version of operating system 160.

System 100 may present an interface between an application layer (or in some examples, a framework layer) exposed by the first version of the operating system and a kernel layer exposed by the second version of the operating system 260. For example, HAL 126, HAL 226, or both HAL 126 and HAL 226 may be the interface. Head unit 102 may stream, via the interface and to the kernel layer exposed by the second version of the operating system 260, information relating to an application executing in the application layer exposed by the first version of the operating system (704). This information relating to the application executing in the application layer exposed by the first version of the operating system may include a first function call that conforms with the first version of the operating system. The interface, e.g., HAL 126, HAL 226, or both HAL 126 and HAL 226, may transform the first function call to a second function call that conforms with the second version of the operating system 260. Supporting computing device 202 may then receive and process the stream of information (including the second function call) to support execution of the application executing in the application layer exposed by the first version of the operating system 160 (706, 708). Supporting computing device 202 may be replaceable or otherwise upgradeable to facilitate adaption of new features, support (in terms of, as an example, end of life services, such as technology support—including software patching and the like to address security and other concerns), and maintenance (in terms of, for example, hardware upgrades —such as processing capabilities, memory size, etc.).

Addition of supporting computing device 202 may allow for upgrades to main computing unit 102 (which is, again, another way to refer to the “head unit” or other computing device) that are less expensive (as supporting computing device 202 is not seamlessly integrated into the vehicle, but only communicatively coupled to head unit 102, thereby relieving expenses associated with the seamless integration, such as form factor, additional components—such as displays, global positioning systems (GPS), etc.). In addition, support of the addition of supporting computing device 202 may enable upgrades to main computing device 102 without having to separately replace main computing device 102, thereby allowing for upgrade of main computing device 102 without having to replace main computing device 102.

In this way, the above described techniques may enable the following examples:

Example 1. A method comprising: executing, by one or more processors of a head unit of a vehicle, a first version of an operating system; executing, by one or more processors of a cartridge communicatively coupled to the head unit within the vehicle, a second version of the operating system; presenting an interface between an application layer exposed by the first version of the operating system and a kernel layer exposed by the second version of the operating system; streaming, via the interface and to the kernel layer exposed by the second version of the operating system, information relating to an application executing in the application layer exposed by the first version of the operating system, wherein the information relating to the application executing in the application layer exposed by the first version of the operating system comprises a first function call that conforms with the first version of the operating system; and transforming, by the interface, the first function call to a second function call that conforms with the second version of the operating system; and processing, by the second version of the operating system, the second function call.

Example 2. The method of example 1, wherein the streaming comprises: generating, by the first version of the operating system, a plurality of packages, the plurality of packages containing the information relating to the application executing in the application layer exposed by the first version of the operating system; serializing, by the first version of the operating system, the plurality of packages; and providing, by the first version of the operating system to the second version of the operating system via the interface, the serialized plurality of packages.

Example 3. The method of example 1, wherein processing, by the second version of the operating system, the second function call comprises processing, by an application executing in an application layer exposed by the second version of the operating system, the information relating to the application executing within the application layer exposed by the first version of the operating system.

Example 4. The method of any combination of examples 1-3, further comprising: generating, by the application executing in the application layer exposed by the second version of the operating system, a third function call that conforms with the second version of the operating system in response to the second function call; providing, by the second version of the operating system to the interface, the third function call, transforming, by the interface, the third function call to a fourth function call that conforms with the first version of the operating system; and processing, by the first version of the operating system, the fourth function call.

Example 5. The method of any combination of examples 1-4, wherein the interface is a first interface, and wherein the method further comprises: presenting a second interface between an application layer exposed by the second version of the operating system and a kernel layer exposed by the first version of the operating system; streaming, via the second interface and to the kernel layer exposed by the first version of the operating system, information relating to an application executing in the application layer exposed by the second version of the operating system, wherein the information relating to the application executing in the application layer exposed by the second version of the operating system comprises a fifth function call that conforms with the second version of the operating system; and transforming, by the second interface, the fifth function call to a sixth function call that conforms with the first version of the operating system; and processing, by the first version of the operating system, the sixth function call.

Example 6. The method of example 5, wherein the plurality of packages is a first plurality of packages, wherein the serialized plurality of packages is a first serialized plurality of packages, and wherein the streaming the information relating to the application executing in the application layer exposed by the second version of the operating system comprises: generating, by the second version of the operating system, a second plurality of packages, the second plurality of packages containing information relating to the application executing in the application layer exposed by the second version of the operating system; serializing, by the second version of the operating system, the second plurality of packages; and providing, by the second version of the operating system to the first version of the operating system via the second interface, the second serialized plurality of packages.

Example 7. The method of example 5 or 6, wherein processing, by the first version of the operating system, the sixth function call comprises processing, by an application executing in an application space of the first version of the operating system, the information relating to the application executing in the application layer exposed by the second version of the operating system.

Example 8. The method of any combination of examples 5-7, wherein the method further comprises: generating, by the application executing in the application layer exposed by the first version of the operating system, a seventh function call that conforms with the first version of the operating system in response to the sixth function call; providing, by the first version of the operating system to the second interface, the seventh function call; transforming, by the second interface, the seventh function call to an eighth function call that conforms with the second version of the operating system; and processing, by the second version of the operating system, the eighth function call.

Example 9. The method of any combination of examples 1-8, wherein the first interface is presented by the one or more processors of the head unit.

Example 10. The method of any combination of examples 1-9, wherein the first interface is presented by the one or more processors of the cartridge.

Example 11. A method comprising: executing, by one or more processors of a head unit of a vehicle, a first version of an operating system; and streaming, via an interface and to a kernel layer exposed by a second version of the operating system executing on one or more processors of a cartridge, information relating to an application executing in the application layer exposed by the first version of the operating system, wherein the information relating to the application executing in the application layer exposed by the first version of the operating system comprises a first function call that conforms with the first version of the operating system, the cartridge being communicatively coupled to the head unit, wherein the interface transforms a first function call that conforms with the first version of the operating system to a second function call that conforms with the second version of the operating system.

Example 12. The method of example 11, wherein the streaming comprises: generating, by the first version of the operating system, a plurality of packages, the plurality of packages containing information relating to the application executing in the application layer exposed by the first version of the operating system; serializing, by the first version of the operating system, the plurality of packages; and providing, by the first version of the operating system to the second version of the operating system via the interface, the serialized plurality of packages.

Example 13. The method of example 11 or 12, further comprising: presenting, by the one or more processors of the head unit, the interface.

Example 14. The method of example 13, further comprising: receiving, at the interface from the second version of the operating system, a third function call that conforms with the second version of the operating system in response to the first function call; transforming, by the interface, the third function call to a fourth function call that conforms with the first version of the operating system; and processing, by the first version of the operating system, the fourth function call.

Example 15. The method of example 13 or 14, receiving, at the interface, a fifth function call that conforms with the second version of the operating system; transforming, by the interface the fifth function call to a sixth function call that conforms with the first version of the operating system; and processing, by the first version of the operating system, the sixth function call.

Example 16. The method of example 15, wherein processing, by the first version of the operating system, the sixth function call comprises processing, by an application running on the first version of the operating system, on the information relating to the application executing in the application layer exposed by the second version of the operating system.

Example 17. The method of example 15 or 16, wherein the method further comprises: generating, by the application executing in the application layer exposed by the first version of the operating system, a seventh function call that conforms with the first version of the operating system in response to the sixth function call; providing, by the first version of the operating system to the interface, the seventh function call; transforming, by the interface, the seventh function call to an eighth function call that conforms with the second version of the operating system; and transmitting, by the interface, the eighth function call to the second version of the operating system.

Example 18. A method comprising: executing, by one or more processors of a cartridge in a vehicle, a second version of an operating system; and receiving a stream, via an interface and to an application layer exposed by a first version of the operating system executing on one or more processors of a head unit of a vehicle, information relating to an application executing in the application layer exposed by the first version of the operating system, wherein the information relating to the application executing in the application layer exposed by the first version of the operating system comprises a first function call that conforms with the first version of the operating system, the cartridge being communicatively coupled to the head unit, wherein the interface transforms a first function call to a second function call that conforms with the second version of the operating system.

Example 19. The method of example 18, further comprising: presenting, by the one or more processors of the cartridge, the interface.

Example 20. The method of example 19, further comprising: generating, by an application executing in an application layer exposed by the second version of the operating system, a third function call that conforms with the second version of the operating system in response to the first function call; receiving, at the interface from the second version of the operating system, the third function call; transforming, by the interface, the third function call to a fourth function call that conforms with the first version of the operating system; and transmitting, by the interface to the first version of the operating system, the fourth function call.

Example 21. The method of example 20, streaming, via the interface and to the kernel layer exposed by the first version of the operating system, information relating to an application executing in the application layer exposed by the second version of the operating system, wherein the information relating to the application executing in the application layer exposed by the second version of the operating system comprises a fifth function call that conforms with the second version of the operating system; and transforming, by the interface, the fifth function call to a sixth function call that conforms with the first version of the operating system; and transmitting, by the interface, the sixth function call to the first version of the operating system.

Example 22. The method of example 21, further comprising: receiving, by the interface, a seventh function call that conforms with the first version of the operating system in response to the sixth function call; transforming, by the interface, the seventh function call to an eighth function call that conforms with the second version of the operating system; and processing, by the second version of the operating system, the eighth function call.

Example 23. The method of any combination of examples 1-22, wherein the first interface is configured to provide security for communications between the first version of the operating system and the second version of the operating system.

Example 24. The method of any combination of examples 1-23, wherein the first interface is configured to list available properties of the vehicle, read a property value, write the property value, subscribe to property updates, and unsubscribed to the property updates.

Example 25. The method of any combination of examples 1-24, wherein the first interface comprises a hardware abstraction layer.

Example 26. The method of any combination of examples 1-25, wherein the first version of the operating system and the second version of the operating system communicate via a universal automotive link.

Example 27. The method of any combination of examples 1-26, wherein the first version of the operating system and the second version of the operating system communicate via a USB connection.

Example 28. The method of any combination of examples 1-27, wherein the wherein the first version of the operating system and the second version of the operating system communicate via a remote procedure call.

Example 29. The method of any combination of examples 1-28, wherein the cartridge is a removable device.

Example 30. The method of any combination of examples 1-29, wherein the first interface provides a bidirectional stream for exchanging function calls between the first version of the operating system and the second version of the operating system.

Example 31. A system comprising: a head unit of a vehicle; an interface, the interface being communicatively coupled to the head unit and being between an application layer exposed by a first version of an operating system executing on one or more processors of the head unit and a kernel layer exposed by a second version of the operating system; and a cartridge, the cartridge being communicatively coupled to the interface and comprising one or more processors executing the second version of the operating system, wherein the first version of the operating system is configured to stream, via the interface and to the kernel layer exposed by the second version of the operating system, information relating to an application executing in the application layer exposed by the first version of the operating system, wherein the information relating to the application executing in the application layer exposed by the first version of the operating system comprises a first function call that conforms with the first version of the operating system, and wherein the interface is configured to transform the first function call to a second function call that conforms with the second version of the operating system, and wherein the second version of the operating system is configured to process the second function call.

Example 32. The system of example 31, wherein, as part of streaming the information relating to an application executing in the application layer exposed by the first version of the operating system, the one or more processors of the head unit are configured to: generate a plurality of packages, the plurality of packages containing the information relating to the application executing in the application layer exposed by the first version of the operating system; serialize the plurality of packages; and provide to the second version of the operating system via the interface, the serialized plurality of packages.

Example 33. The system of example 31, wherein, as part of processing the second function call, the one or more processors of the cartridge are configured to execute an application in an application layer exposed by the second version of the operating system to process the information relating to the application executing within the application layer exposed by the first version of the operating system.

Example 34. The system of any combination of examples 31-33, wherein the one or more processors of the cartridge are further configured to: generate, through the application executing in the application layer exposed by the second version of the operating system, a third function call that conforms with the second version of the operating system in response to the second function call; and provide, to the interface, the third function call; wherein the interface is further configured to transform the third function call to a fourth function call that conforms with the first version of the operating system, and wherein the one or more processors of the head unit are further configured to process the fourth function call.

Example 35. The system of any combination of examples 31-34, wherein the interface is a first interface, and wherein the system further comprises a second interface between an application layer exposed by the second version of the operating system and a kernel layer exposed by the first version of the operating system, the second interface being configured to transform a fifth function call that conforms with the second version of the operating system to a sixth function call that conforms with the first version of the operating system, wherein the one or more processors of the cartridge are further configured to stream, via the second interface and to the kernel layer exposed by the first version of the operating system, information relating to an application executing in the application layer exposed by the second version of the operating system, wherein the information relating to the application executing in the application layer exposed by the second version of the operating system comprises the fifth function call, and wherein the one or more processors of the head unit are further configured to process the sixth function call.

Example 36. The system of example 35, wherein the plurality of packages is a first plurality of packages, wherein the serialized plurality of packages is a first serialized plurality of packages, and wherein as part of streaming the information relating to the application executing in the application layer exposed by the second version of the operating system, the one or more processors of the cartridge are configured to: generate a second plurality of packages, the second plurality of packages containing information relating to the application executing in the application layer exposed by the second version of the operating system; serialize the second plurality of packages; and provide, to the first version of the operating system via the second interface, the second serialized plurality of packages.

Example 37. The system of example 35 or 36, wherein, as part of processing the sixth function call, the one or more processors of the head unit are configured to execute the application in the application layer exposed by the first version of the operating system to process the information relating to the application executing in the application layer exposed by the second version of the operating system.

Example 38. The system of any combination of examples 35-37, wherein the one or more processors of the head unit are further configured to: generate, through the application executing in the application layer exposed by the first version of the operating system, a seventh function call that conforms with the first version of the operating system in response to the sixth function call; and provide, to the second interface, the seventh function call, wherein the second interface is further configured to transform the seventh function call to an eighth function call that conforms with the second version of the operating system, and wherein the one or more processors of the head unit are further configured to process the eighth function call.

Example 39. The system of any combination of examples 31-38, wherein the first interface is presented by the one or more processors of the head unit.

Example 40. The system of any combination of examples 31-39, wherein the first interface is presented by the one or more processors of the cartridge.

Example 41. The system of any combination of examples 31-40, wherein the first interface is configured to provide security for communications between the first version of the operating system and the second version of the operating system.

Example 42. The system of any combination of examples 31-41, wherein the first interface is configured to list available properties of the vehicle, read a property value, write the property value, subscribe to property updates, and unsubscribed to the property updates.

Example 43. The system of any combination of examples 31-42, wherein the first interface comprises a hardware abstraction layer.

Example 44. The system of any combination of examples 31-43, wherein the first version of the operating system and the second version of the operating system communicate via a universal automotive link.

Example 45. The system of any combination of examples 31-44, wherein the first version of the operating system and the second version of the operating system communicate via a USB connection.

Example 46. The system of any combination of examples 31-45, wherein the wherein the first version of the operating system and the second version of the operating system communicate via a remote procedure call.

Example 47. The system of any combination of examples 31-46, wherein the cartridge is a removable device.

Example 48. The system of any combination of examples 31-47, wherein the first interface provides a bidirectional stream for exchanging function calls between the first version of the operating system and the second version of the operating system.

Example 49. A head unit comprising: a memory; and one or more processors implemented in circuitry and communicatively coupled to the memory, the one or more processors being configured to: execute a first version of an operating system; and stream, via an interface and to a kernel layer exposed by a second version of the operating system executing on one or more processors of a cartridge, information relating to an application executing in the application layer exposed by the first version of the operating system, wherein the information relating to the application executing in the application layer exposed by the first version of the operating system comprises a first function call that conforms with the first version of the operating system, the cartridge being communicatively coupled to the head unit, wherein the interface transforms a first function call that conforms with the first version of the operating system to a second function call that conforms with the second version of the operating system.

Example 50. The head unit of example 49, wherein as part of streaming the information relating to an application executing in the application layer exposed by the first version of the operating system, the one or more processors of the head unit are configured to: generate a plurality of packages, the plurality of packages containing information relating to the application executing in the application layer exposed by the first version of the operating system; serialize the plurality of packages; and provide, to the second version of the operating system via the interface, the serialized plurality of packages.

Example 51. The head unit of example 49 or 50, wherein the one or more processors of the head unit are further configured to present the interface.

Example 52. The head unit of example 51, wherein the one or more processors of the head unit are further configured to: receive, at the interface from the second version of the operating system, a third function call that conforms with the second version of the operating system in response to the first function call; transform the third function call to a fourth function call that conforms with the first version of the operating system; and process the fourth function call.

Example 53. The head unit of example 51 or claim 52, wherein the one or more processors of the head unit are further configured to: receive a fifth function call that conforms with the second version of the operating system; transform the fifth function call to a sixth function call that conforms with the first version of the operating system; and process the sixth function call.

Example 54. The head unit of example 53, wherein as part of processing the sixth function call, the one or more processors of the head unit are configured to execute the application in the application layer exposed by the first version of the operating system to process the information relating to the application executing in the application layer exposed by the second version of the operating system.

Example 55. The head unit of example 53 or 54, wherein the one or more processors of the head unit are further configured to: generate a seventh function call that conforms with the first version of the operating system in response to the sixth function call; transform the seventh function call to an eighth function call that conforms with the second version of the operating system; and transmit the eighth function call to the second version of the operating system.

Example 56. A cartridge comprising: a memory; and one or more processors implemented in circuitry and communicatively coupled to the memory, the one or more processors being configured to: execute a second version of an operating system; and receive a stream, via an interface and to an application layer exposed by a first version of the operating system executing on one or more processors of a head unit of a vehicle, information relating to an application executing in the application layer exposed by the first version of the operating system, wherein the information relating to the application executing in the application layer exposed by the first version of the operating system comprises a first function call that conforms with the first version of the operating system, the cartridge being communicatively coupled to the head unit, wherein the interface transforms the first function call to a second function call that conforms with the second version of the operating system.

Example 57. The cartridge of example 56, wherein the one or more processors of the cartridge are further configured to: present the interface.

Example 58. The cartridge of example 57, wherein the one or more processors of the cartridge are further configured to: generate, through an application executing in an application layer exposed by the second version of the operating system, a third function call that conforms with the second version of the operating system in response to the second function call; transform the third function call to a fourth function call that conforms with the first version of the operating system; and transmit, to the first version of the operating system, the fourth function call.

Example 59. The cartridge of example 58, wherein the one or more processors of the cartridge are further configured to: stream, to the kernel layer exposed by the first version of the operating system, information relating to an application executing in the application layer exposed by the second version of the operating system, wherein the information relating to the application executing in the application layer exposed by the second version of the operating system comprises a fifth function call that conforms with the second version of the operating system; and transform the fifth function call to a sixth function call that conforms with the first version of the operating system; and transmit the sixth function call to the first version of the operating system.

Example 60. The cartridge of example 59, wherein the one or more processors of the cartridge are further configured to: receive a seventh function call that conforms with the first version of the operating system in response to the sixth function call; transform the seventh function call to an eighth function call that conforms with the second version of the operating system; and process the eighth function call.

Example 61. A computer-readable storage medium storing instructions, which, when executed cause one or more processors of a system in a vehicle to: execute a first version of an operating system; execute a second version of the operating system; present an interface between an application layer exposed by the first version of the operating system and a kernel layer exposed by the second version of the operating system; stream, via the interface and to the kernel layer exposed by the second version of the operating system, information relating to an application executing in the application layer exposed by the first version of the operating system, wherein the information relating to the application executing in the application layer exposed by the first version of the operating system comprises a first function call that conforms with the first version of the operating system; and transform the first function call to a second function call that conforms with the second version of the operating system; and process the second function call.

Example 62. A system comprising: means for executing a first version of an operating system; means for executing a second version of the operating system; means for presenting an interface between an application layer exposed by the first version of the operating system and a kernel layer exposed by the second version of the operating system; means for streaming, via the interface and to the kernel layer exposed by the second version of the operating system, information relating to an application executing in the application layer exposed by the first version of the operating system, wherein the information relating to the application executing in the application layer exposed by the first version of the operating system comprises a first function call that conforms with the first version of the operating system; and means for transforming the first function call to a second function call that conforms with the second version of the operating system; and means for processing the second function call.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, ultra Blu-ray, etc. where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used may refer to any of the foregoing structure or any other structure suitable for implementation of the techniques described. In addition, in some aspects, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

1. A method comprising:
executing, by one or more processors of a cartridge in a vehicle, a second version of an operating system; and
receiving a stream, via an interface and from an application layer exposed by a first version of the operating system executing on one or more processors of a head unit of a vehicle, information relating to an application executing in the application layer exposed by the first version of the operating system, wherein the information relating to the application executing in the application layer exposed by the first version of the operating system comprises a first function call that conforms with the first version of the operating system, the cartridge being communicatively coupled to the head unit,
wherein the interface transforms a first function call to a second function call that conforms with the second version of the operating system.

2. The method of claim 2, further comprising presenting, by the one or more processors of the cartridge, the interface.

3. The method of claim 2, further comprising:
generating, by an application executing in an application layer exposed by the second version of the operating system, a third function call that conforms with the second version of the operating system in response to the first function call;
receiving, at the interface from the second version of the operating system, the third function call;
transforming, by the interface, the third function call to a fourth function call that conforms with the first version of the operating system; and
transmitting, by the interface to the first version of the operating system, the fourth function call.

4. The method of claim 3, further comprising:
streaming, via the interface and to the kernel layer exposed by the first version of the operating system, information relating to an application executing in the application layer exposed by the second version of the operating system, wherein the information relating to the application executing in the application layer exposed by the second version of the operating system comprises a fifth function call that conforms with the second version of the operating system;
transforming, by the interface, the fifth function call to a sixth function call that conforms with the first version of the operating system; and
transmitting, by the interface, the sixth function call to the first version of the operating system.

5. The method of claim 4, further comprising:
receiving, by the interface, a seventh function call that conforms with the first version of the operating system in response to the sixth function call;
transforming, by the interface, the seventh function call to an eighth function call that conforms with the second version of the operating system; and
processing, by the second version of the operating system, the eighth function call.

6. The method of claim 1, wherein the first interface is configured to provide security for communications between the first version of the operating system and the second version of the operating system.

7. The method of claim 1, wherein the first interface is configured to list available properties of the vehicle, read a property value, write the property value, subscribe to property updates, and unsubscribed to the property updates.

8. The method of claim 1, wherein the first interface comprises a hardware abstraction layer.

9. The method of claim 1, wherein the first version of the operating system and the second version of the operating system communicate via a universal automotive link.

10. The method of claim 1, wherein the first version of the operating system and the second version of the operating system communicate via a USB connection.

11. The method of claim 1, wherein the wherein the first version of the operating system and the second version of the operating system communicate via a remote procedure call.

12. The method of claim 1, wherein the cartridge is a removable device.

13. The method of cm claim 1, wherein the first interface provides a bidirectional stream for exchanging function calls between the first version of the operating system and the second version of the operating system.

14. A cartridge comprising:
a memory; and
one or more processors implemented in circuitry and communicatively coupled to the memory, the one or more processors being configured to:
execute a second version of an operating system; and
receive a stream, via an interface and from an application layer exposed by a first version of the operating system executing on one or more processors of a head unit of a vehicle, information relating to an application executing in the application layer exposed by the first version of the operating system, wherein the information relating to the application executing in the application layer exposed by the first version of the operating system comprises a first function call that conforms with the first version of the operating system, the cartridge being communicatively coupled to the head unit,
wherein the interface transforms the first function call to a second function call that conforms with the second version of the operating system.

15. The cartridge of claim 14, wherein the one or more processors of the cartridge are further configured to present the interface.

16. The cartridge of claim 15, wherein the one or more processors of the cartridge are further configured to:
generate, through an application executing in an application layer exposed by the second version of the operating system, a third function call that conforms with the second version of the operating system in response to the second function call;
transform the third function call to a fourth function call that conforms with the first version of the operating system; and
transmit, to the first version of the operating system, the fourth function call.

17. The cartridge of claim 16, wherein the one or more processors of the cartridge are further configured to:
stream, to the kernel layer exposed by the first version of the operating system, information relating to an application executing in the application layer exposed by the second version of the operating system, wherein the information relating to the application executing in the application layer exposed by the second version of the operating system comprises a fifth function call that conforms with the second version of the operating system;
transform the fifth function call to a sixth function call that conforms with the first version of the operating system; and
transmit the sixth function call to the first version of the operating system.

18. The cartridge of claim 17, wherein the one or more processors of the cartridge are further configured to:
receive a seventh function call that conforms with the first version of the operating system in response to the sixth function call;
transform the seventh function call to an eighth function call that conforms with the second version of the operating system; and
process the eighth function call.

19. The cartridge of claim 14, wherein the cartridge is a removable device.

20. A non-transitory computer-readable storage medium having instructions stored thereon that, when executed, cause one or more processors of a cartridge to:
execute a second version of an operating system; and
receive a stream, via an interface and from an application layer exposed by a first version of the operating system executing on one or more processors of a head unit of a vehicle, information relating to an application executing in the application layer exposed by the first version of the operating system, wherein the information relating to the application executing in the application layer exposed by the first version of the operating system comprises a first function call that conforms with the first version of the operating system, the cartridge being communicatively coupled to the head unit,
wherein the interface transforms a first function call to a second function call that conforms with the second version of the operating system.
